(19) United States
(12) Patent Application Publication
(10) Pub. No.: US 2001/0053990 A1
(43) Pub. Date: Dec. 20, 2001

(54) CONSTRUCTION OF SYSTEM WITH REDUCED LOAD ON SYSTEM ENGINEERS

(75) Inventor: YOSHIAKI SHUTO, KAWASAKI-SHI (JP)

Correspondence Address: STAAS & HALSEY LLP, 700 11TH STREET, NW, SUITE 500, WASHINGTON, DC, 20001, US

(73) Assignee: FUJITSU LIMITED OF Kawasaki, Japan

(21) Appl. No.: 09/210,892

(22) Filed: Dec. 16, 1998

(30) Foreign Application Priority Data
Dec. 19, 1997 (JP) 9-351680

(51) Int. Cl. G06F 17/60

(52) U.S. Cl. 705/7

(57) ABSTRACT

A method of constructing a system by collecting information and know-how is presented. The method includes the steps of storing information including development situations, know-how, and knowledge in a solution bank by a unit of a solution pattern, and obtaining contents corresponding to a desired system so as to construct the desired system by accessing the solution bank from a computer in which the desired system is to be constructed.

### BACKGROUND OF THE INVENTION

1. Field of the Invention

The present invention relates to a method and a device for constructing a system as well as a memory medium storing a program for constructing a system. Operations of a business corporation usually cover a wide variety of areas involving various types of work even if the whole business is contained in one industry. Such various types of work are generally compartmentalized, and are assigned to individuals who will be in charge of the assigned work. Such individuals are in possession of the knowledge and know-how of details of the assigned work. A particular individual and department, however, should not retain such knowledge for their exclusive use, and should make it open to other individuals, affiliates of the company, customers, etc., thereby reducing a time for development of products and making efficient use of the time. The present invention particularly relates to a method and a device for constructing such a system as well as a memory medium storing a program for constructing such a system.

In development of software products, in particular, there is a need for a means to learn about details of software development which is underway in other departments. The present invention further relates to a method and a device for constructing a system as well as a memory medium storing a program for constructing a system which permits shared use of the knowledge and know-how of developments between different departments.

2. Description of the Related Art

FIG. 1 is an illustrative drawing for explaining related-art install tools.

In the related art, an operation system (hereinafter, referred to simply as OS) is first installed as shown in the figure. At the next step, RDBMS products, OLTP products, software-development programming language, host-related software, and software-development components are installed. Then, settings are made to the environment of the OS and the RDBMS with respect to the RDBMS products, and parameter changes are also made. With regard to the OLTP products, changes are made to the OS environment, and the OLTP products are installed. Further, settings to the environment are made with respect to the host-related software. After all of these, operations of each product are checked, and a connection is confirmed as shown in the figure.

When customers try to introduce a new system package, system engineers make an arrangement that a pertinent system-development division provides consultation, demonstration, and the like for the customers. The system engineers then customize the system so as to satisfy the customer needs, and have the system package delivered to the customers.

FIG. 2 is an illustrative drawing showing tasks carried out by the system engineers in the related art.

As shown in the figure, upon talks with a customer, system engineers search for cases which are applicable to the customer's business, and have a demonstration conducted at an application plaza or at an office of a demonstration-development division. After seeing the customer's reaction to the demonstration, the system engineers ask an SI-support division or a system-technology-develop division to consult the customer. After the consultations, the system engineers arrange delivery of necessary software products, and wait until all the software products are obtained. When everything is supplied, the system engineers install the products in hardware, and execute a test program to check operations. Further, the system engineers build a target system by using standardization rules so as to satisfy the needs of the customer.

In this process, it is necessary to install and setup each product as well as to confirm a connection for each product. This results in a lengthy time being needed before establishing links between all the products and making all of them operational.

Further, setting of the environment of each product requires know-how about optimization of parameters so as to achieve a faster operation speed and about handling of troubles such as a failure to establish a connection and a failure to make it operational, for example. Because of this, setting of the environment needs to be handled by experts having specialized knowledge.

Another problem is that wrong settings or inadvertent omission of some settings can happen during the course of a setting operation for setting each of a computer name, an IP address, user information, etc.

When a customer tries to introduce a new system package, the most appropriate package in terms of meeting the customer's needs should be selected for the customer, and such a selection is made based on the information, collected from the development divisions, about what kinds of software and hardware are available as products. In this case, if the number of the development divisions is large, the system engineers doing all of this task may suffer the increased load. Also, this leads to a situation in which a bundle of products are sold to the customer, including something that the customer does not use, thereby resulting in a cost increase on the side of the customer.

FIG. 3 is an illustrative drawing showing an example of a flow through which software products are delivered and a setup is made.

As shown in FIG. 3, system engineers first design a system configuration. The system engineers then prepare specifications for software products, headers, and scripts of the application environment, and place an order to the procurement department. A waiting period typically ranges from two weeks to one month. In general, all the products do not come in one delivery, but rather each is delivered individually. The system engineers need to wait until all the products are supplied, and, thereafter, install these products one by one in computer. A setup operation is then performed, and a check is made with regard to operations of the system before the system changes hands from the system engineers to the customer. If bugs are found in a software product, an order must be placed for a replacing product. If the software products do not perform well to satisfy the customer, the system operation may be halted to install these products again or to check the products. All of these described above add to the load on the system engineer.

Accordingly, there is a need for a method of, a device for, and a memory medium storing a program for constructing a system, which satisfy the followings. A system construction follows a formatted pattern so as to guarantee quality and performance to be satisfactory. A modeling system and know-how of construction are provided for system engineers to reduce the load on the system engineers. During the course of construction of the system, a system engineer can perform a demonstration of operations at his/her own desk. The contents of the application environment and the programming environment are stored with respect to each solution pattern.

Further, there is a need for a method of, a device for, and a memory medium storing a program for constructing a system, which provide an environment for a default system to operate by means of PP, headers, components, scripts, etc., and permit an easy installment with a capacity to finish delivery of software and a setup operation within a matter of a day or two rather than taking such a lengthy time period as two weeks to one month as required in the related art.

Moreover, there is a need for a method of, a device for, and a memory medium storing a program for constructing a system, which can customize a default system at a solution-bank center, and can supply the system to the customer after a fine tuning thereof.

Also, there is a need for a method of, a device for, and a memory medium storing a program for constructing a system, which can provide the system along with design documents of the default system.

Further, there is a need for a method of, a device for, and a memory medium storing a program for constructing a system, which allows a check on the system operation to be conducted only with respect to a portion of the system by downloading this portion so that the evaluation of the system can be made even before delivery of software that meets the customer needs.

Moreover, there is a need for a method of, a device for, and a memory medium storing a program for constructing a system, which can categorize systems by business transaction models.

Also, there is a need for a method of, a device for, and a memory medium storing a program for constructing a system, which can attain high quality and productivity by making reuse of checked components built in the default system and sample applications.

### SUMMARY OF THE INVENTION

Accordingly, it is a general object of the present invention to provide a method of, a device for, and a memory medium storing a program for constructing a system, which can satisfy the needs described above.

It is another and more specific object of the present invention to provide a method of, a device for, and a memory medium storing a program for constructing a system, which satisfy the followings. A system construction follows a formatted pattern so as to guarantee quality and performance to be satisfactory. A modeling system and know-how of construction are provided for system engineers to reduce the load on the system engineers. During the course of construction of the system, a system engineer can use operational demonstration from his/her own desk. The contents of the application environment and the programming environment are stored with respect to each solution pattern.

In order to achieve the above objects according to the present invention, a method of constructing a system by collecting information and know-how, includes the steps of storing information including development situations, know-how, and knowledge in a solution bank by a unit of a solution pattern, and obtaining contents corresponding to a desired system so as to construct the desired system by accessing the solution bank from a computer in which the desired system is to be constructed.

According to one aspect of the present invention, the method described above is such that the solution bank stores information on an application environment including proposals, designs, software, know-how, and a programming environment.

According to another aspect of the present invention, the method described above is such that the step of obtaining contents includes the steps of accessing the solution bank based on information including a business model, transaction forms, and a project size, and selecting items of desired information from items presented by the solution bank.

According to another aspect of the present invention, the method described above is such that the step of obtaining contents includes the steps of accessing the solution bank based on information including a solution pattern, a machine being used, a product being used, and supplying an application environment of a default system from the solution bank to the computer in which the desired system is to be constructed.

According to another aspect of the present invention, the method described above is such that the step of obtaining contents further includes the step of supplying design documents of the default system from the solution bank to the computer in which the desired system is to be constructed.

According to another aspect of the present invention, the method described above is such that the solution bank provides a solution pattern categorized according to a business-transaction model which is requested by the computer in which the desired system is to be constructed.

According to another aspect of the present invention, the method described above is such that the solution bank provides only a partial function of a solution pattern for the computer in which the desired system is to be constructed.

According to another aspect of the present invention, the method described above further includes the steps of checking components incorporated into a default system which is used as a basis for the desired system, and utilizing the checked components for a computer in which another system is to be constructed.

According to another aspect of the present invention, a system for constructing a system by collecting information and know-how includes:

a solution bank including:

content storing means for storing information including development situations, know-how, and knowledge by a unit of a solution pattern; and

solution-pattern providing means for providing the information stored in the content storing means as a solution pattern or a portion of the solution pattern in response to a request; and

a system-construction device which obtains contents corresponding to a desired system from the solution bank so as to construct the desired system by accessing the solution bank.

According to another aspect of the present invention, the system described above is such that the solution bank stores information on an application environment including proposals, designs, software, know-how, and a programming environment.

According to another aspect of the present invention, the system described above is such that the system-construction device includes accessing means for accessing the solution bank based on information including a business model, transaction forms, and a project size, and selecting means for selecting items of desired information from items presented by the solution bank.

According to another aspect of the present invention, the system described above is such that the access means accesses the solution bank based on information including a solution pattern, a machine being used, a product being used, and the solution-pattern providing means supplies an application environment of a default system from the solution bank to the system-construction device.

According to another aspect of the present invention, the system described above is such that the solution-pattern providing means further supplies design documents of the default system from the solution bank to the system-construction device.

According to another aspect of the present invention, the system described above is such that the solution-pattern providing means provides a solution pattern categorized according to a business-transaction model which is requested by the system-construction device.

According to another aspect of the present invention, the system as described above is such that the solution-pattern providing means provides only a partial function of a solution pattern for the system-construction device.

According to another aspect of the present invention, a machine-readable memory medium having a program embodied therein for constructing a system by collecting information and know-how is presented. The program includes a solution-pattern providing program-code device configured to cause a solution bank, which stores information including development situations, know-how, and knowledge by a unit of a solution pattern, to provide the information as a solution pattern or a portion of the solution pattern in response to a request, and a system-construction program-code device configured to cause a system-construction device to obtain contents corresponding to a desired system from the solution bank so as to construct the desired system by accessing the solution bank.

According to the present invention described above, contents are stored in the solution bank by a unit of a solution, and are supplied as a solution in its entirety or as a portion of the solution in response to an access from the system-construction device operated by a system engineer. In this configuration, the system engineer does not have to arrange delivery of each component and tool in accordance with the business practice of the customer, and only notifies the solution bank of necessary information to obtain appropriate contents corresponding to the business practice. All of these can be done by working on a device provided at the system-engineer's own desk or at a site of the customer. Namely, the system engineer can obtain the contents, perform a demonstration, etc., without leaving his/her own desk or the customer site.

Further, the solution bank according to the present invention includes information on an application environment including proposals, designs, software, know-how, and a programming environment, thereby making it possible to provide contents suitable for the business practice of the customer by selecting such contents from various application environments. Namely, there is no need for the system engineer himself/herself to find necessary contents, thereby reducing the load on the system engineers.

Moreover, the solution bank is accessed by the system engineer based on the information including a business model, transaction forms, and a project size, and the items of the information supplied from the solution bank is subjected to a selection of necessary items. This achieves elimination of unnecessary information, leaving only the items which satisfy the customer needs.

Also, the solution bank is accessed by the system engineer when the system engineer specifies a solution pattern, a machine being used, a product being used. In response, the solution bank provides the application environment of the default system in one batch. This eliminates a need to construct a default system step by step by collecting individual components, thereby shortening a system-construction time.

Further, design documents of the default system can be obtained from the solution bank in one batch, so that the system engineer does not have to collect the design documents one by one for each design. This results in a reduction in a system construction time.

Moreover, a solution pattern is categorized according to the business transaction model, and is provided from the solution bank. This reduces the load imposed on the system engineer, and makes it possible to complete the procurement of software and the setting up of the system within a matter of a day or two while it would have taken at least two weeks to one month in the related art.

Further, only a partial function of the contents can be obtained from the solution bank, so that a test run may be conducted to provide an evaluation of the partial function with an aim of helping in determining whether to purchase the entire function. This allows an evaluation to be made with regard to software before ordering the software, helping to determine a general direction toward the construction of the system. Since the partial function is actually presented to the customer, it helps the customer to visualize the picture of the system for the better understanding thereof.

Also, contents incorporated into the default system are checked, so that the checked components are reused when another system engineer requests these components. This achieves a high productivity, and renders a high quality to the system.

Other objects and further features of the present invention will be apparent from the following detailed description when read in conjunction with the accompanying drawings.

### BRIEF DESCRIPTION OF THE DRAWINGS

FIG. 1 is an illustrative drawing for explaining related-art install tools;

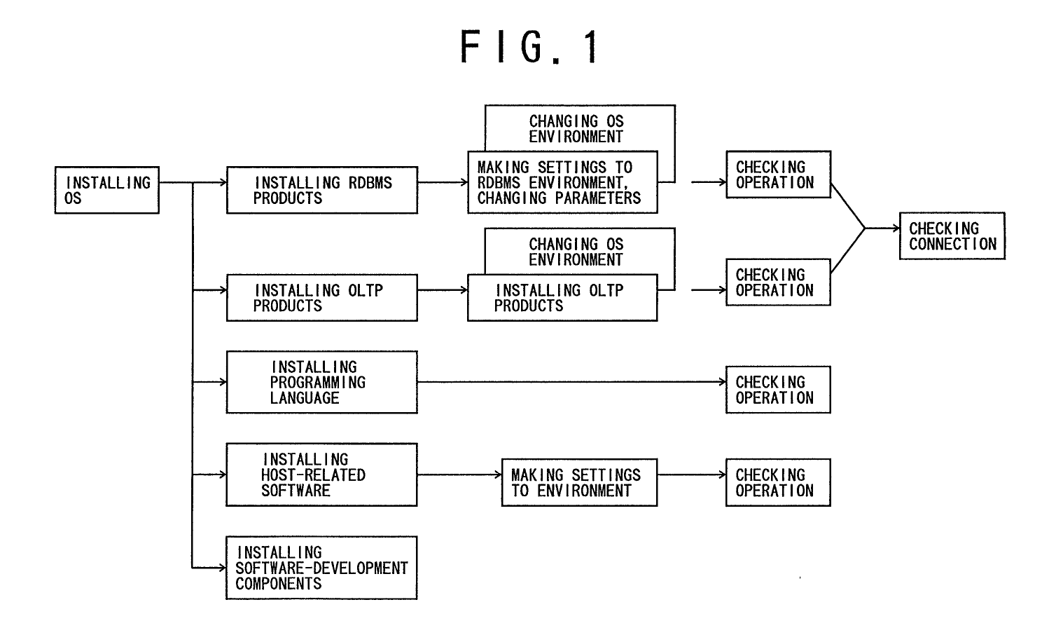

FIG. 2 is an illustrative drawing showing tasks carried out by system engineers in the related art;

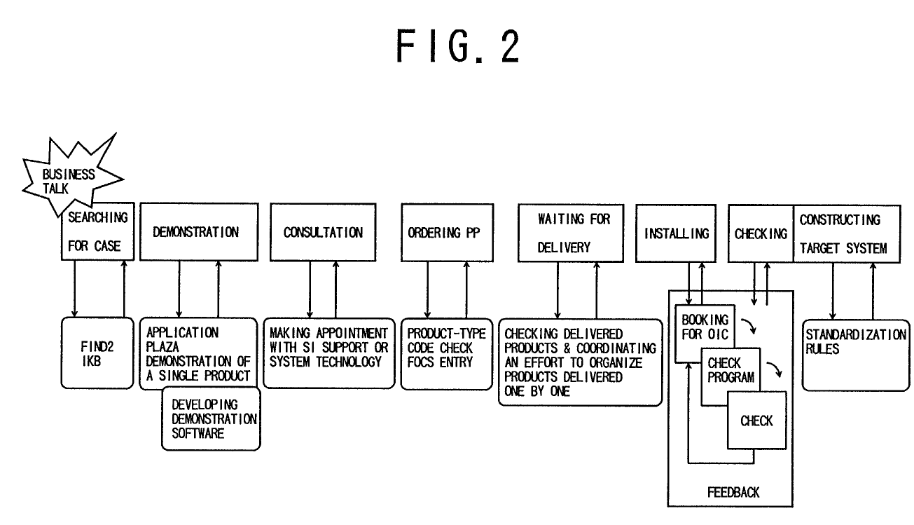

FIG. 3 is an illustrative drawing showing an example of a flow through which software products are delivered and a setup is made;

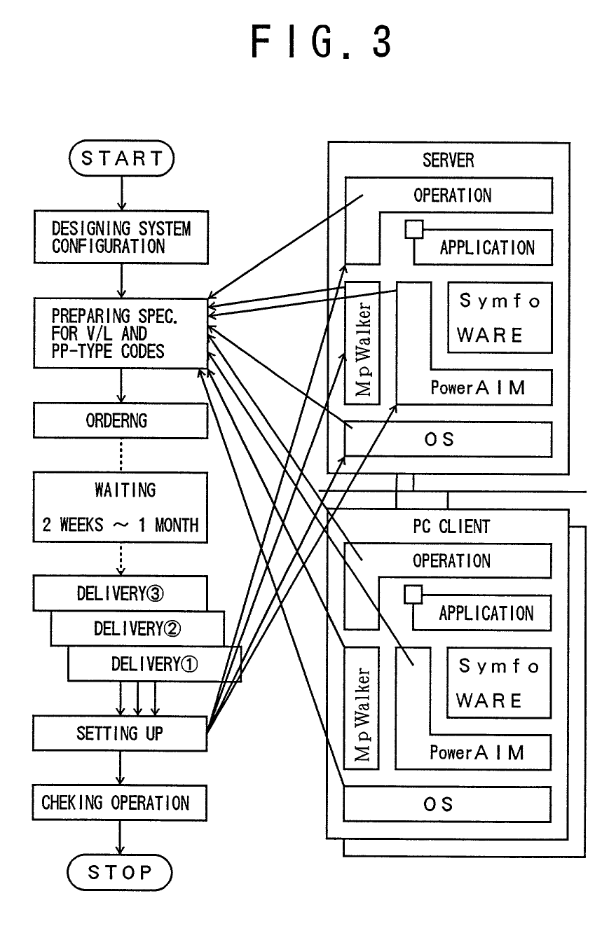

FIG. 4 is an illustrative drawing showing a configuration of a system-construction system based on a solution bank according to the present invention;

FIG. 5 is a flowchart showing operations of a system-construction-know-how extracting device according to the present invention;

FIG. 6 is an illustrative drawing for explaining how a demonstration system of the present invention works;

FIG. 7 is an illustrative drawing for explaining an application environment of a default system;

FIG. 8 is an illustrative drawing for explaining a method of providing a default system;

FIG. 9 is a flowchart of operations performed at the time of providing a default system according to the present invention;

FIG. 10 is an illustrative drawing showing an example of default-system-design documents;

FIG. 11 is a flowchart combined with an illustrative drawing for explaining the downloading of a partial function;

FIG. 12 is a flowchart for explaining a process of categorization according to the present invention;

FIG. 13 is an illustrative drawing showing an example of a hierarchical structure;

FIG. 14 is an illustrative drawing for explaining a process of evaluating software before a delivery thereof to a customer according to the present invention;

FIG. 15 is an illustrative drawing showing a process of generating an installment medium;

FIG. 16 is an illustrative drawing showing a process of installing all components;

FIG. 17 is an illustrative drawing showing a procedure that system engineers follow according to the present invention;

FIG. 18 is an illustrative drawing for explaining reuse of components;

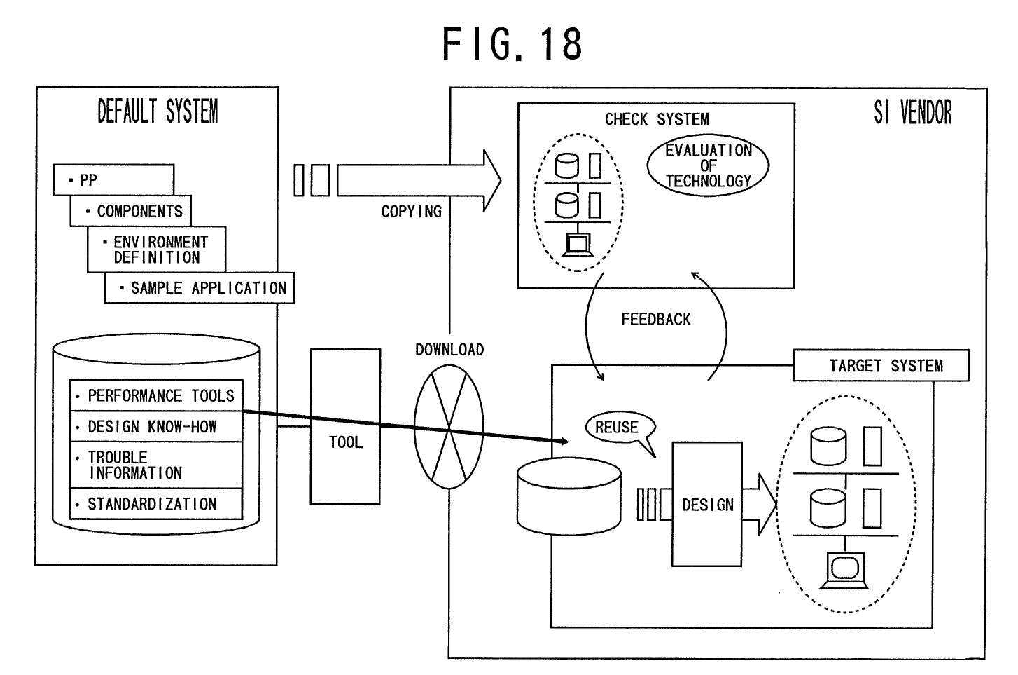

FIG. 19 is an illustrative drawing showing an example of a displayed screen used at the time of solution-pattern selection according to an embodiment of the present invention;

FIG. 20 is an illustrative drawing showing an example of another displayed screen used at the time of solution-pattern selection;

FIG. 21 is an illustrative drawing showing an example of yet another displayed screen used at the time of solution-pattern selection; and

FIG. 22 is an illustrative drawing showing an example of a list of software products used by customers.

### DESCRIPTION OF THE PREFERRED EMBODIMENTS

In the following, embodiments of the present invention will be described with reference to the accompanying drawings.

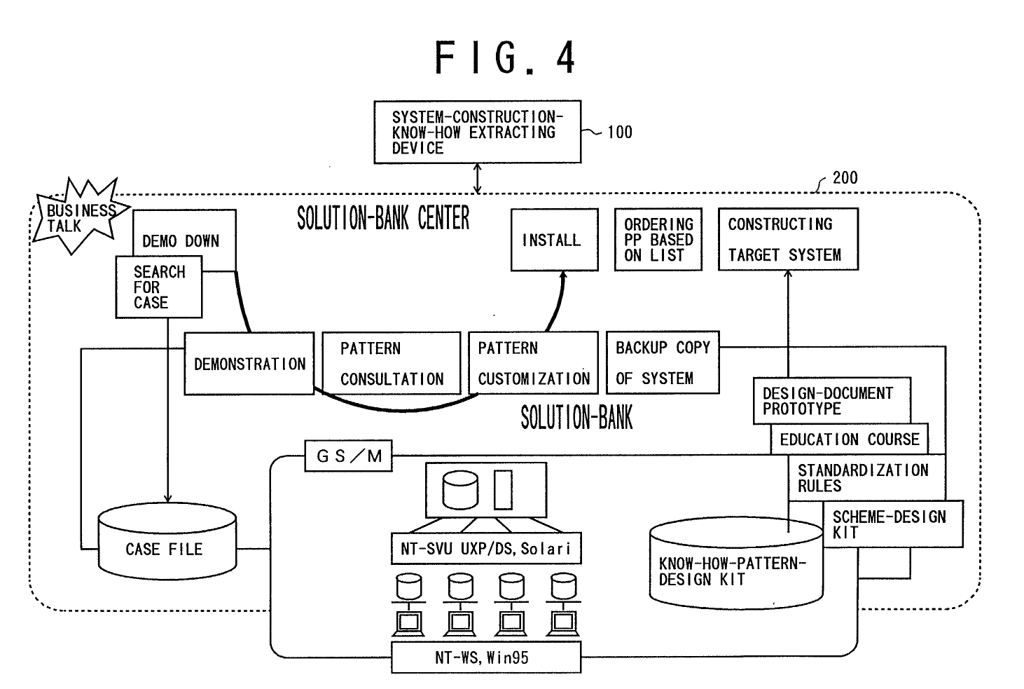

FIG. 4 is an illustrative drawing showing a configuration of a system-construction system based on a solution bank according to the present invention.

The system of FIG. 4 includes a system-construction-know-how extracting device 100 and a solution-bank center 200.

The system-construction-know-how extracting device 100 is used by system engineers and customers, and is connected to the solution-bank center 200 via a network or the like. The system-construction-know-how extracting device 100 is equipped with a function to extract exemplary cases or the know-how of designs or the like from the solution-bank center 200, and, also, is equipped with a function to install the extracted information in the system-construction-know-how extracting device 100.

The solution-bank center 200 searches for factual-case files or know-how-pattern-design kits in response to an access from the system-construction-know-how extracting device 100, and retrieves exemplary cases, design formats, a guide to an educational course, standardization rules, means-design kits, etc.

In what follows, operations will be described with regard to a case in which a system engineer accesses the solution-bank center 200 from his/her own terminal for the purpose of demonstrate operations of a system.

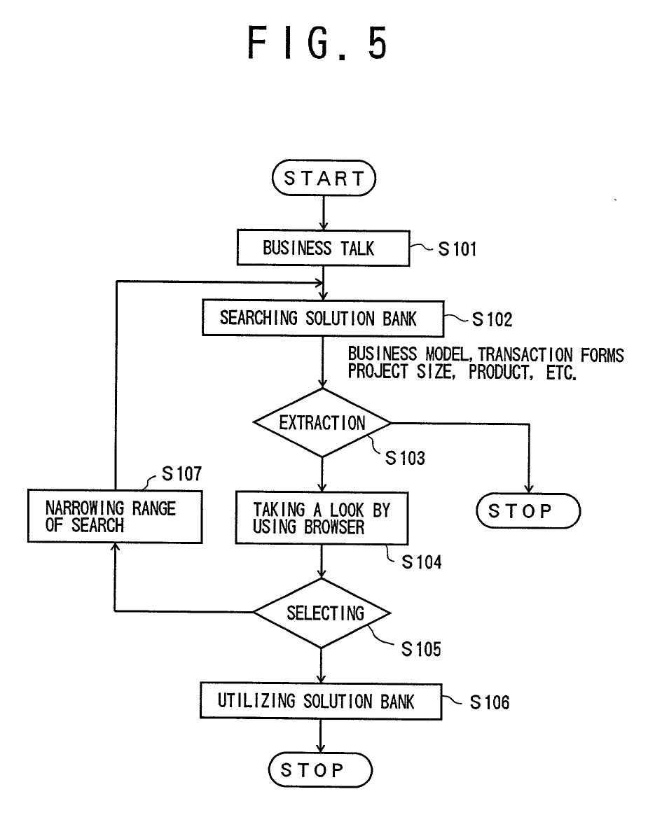

FIG. 5 is a flowchart showing operations of the system-construction-know-how extracting device 100 according to the present invention.

At a step S101, a business talk is held with a customer with regard to the construction of a particular system.

At a step S102, the system engineer makes a search request to the solution-bank center 200 with regard to business models, transaction forms, project sizes, products to be delivered to the customer, etc.

At a step S103, the solution-bank center 200 searches for factual-pattern files and know-how-pattern-design kits. If searched objects are retrieved, the procedure goes to the step S104. Otherwise, the procedure is brought to a halt. In the latter case, another search may be conducted by using other search keywords.

At a step S104, since the search came up with retrieved results, a close look is taken at the retrieved information by using a browser provided in the system-construction-know-how extracting device 100. Here, the retrieved information includes tags indicating item names or the like attached to respective items of information for indication purposes.

At a step S105, the system engineer selects tags which are applicable to the customer. If the selection of the tags is made, the procedure goes to a step S106. If the selection of tags is difficult to make because of an excessive number of the tags, the procedure goes to a step S107.

At the step S106, the system-construction-know-how extracting device 100 uses an installment function thereof to install therein the exemplary cases or the know-how patterns from the solution-bank center 200 based on the tags selected at the step S105.

At the step S107, when it is difficult to select tags because an excessive number of tags are resulted from the use of current search keys, another search is conducted in the solution-bank center 200 after narrowing the range of search by changing the search keys. Then, the procedure goes back to the step S102.

In what follows, operations will be described with regard to a case in which the system engineer or the customer performs a demonstration based on sample programs by accessing the solution-bank center 200.

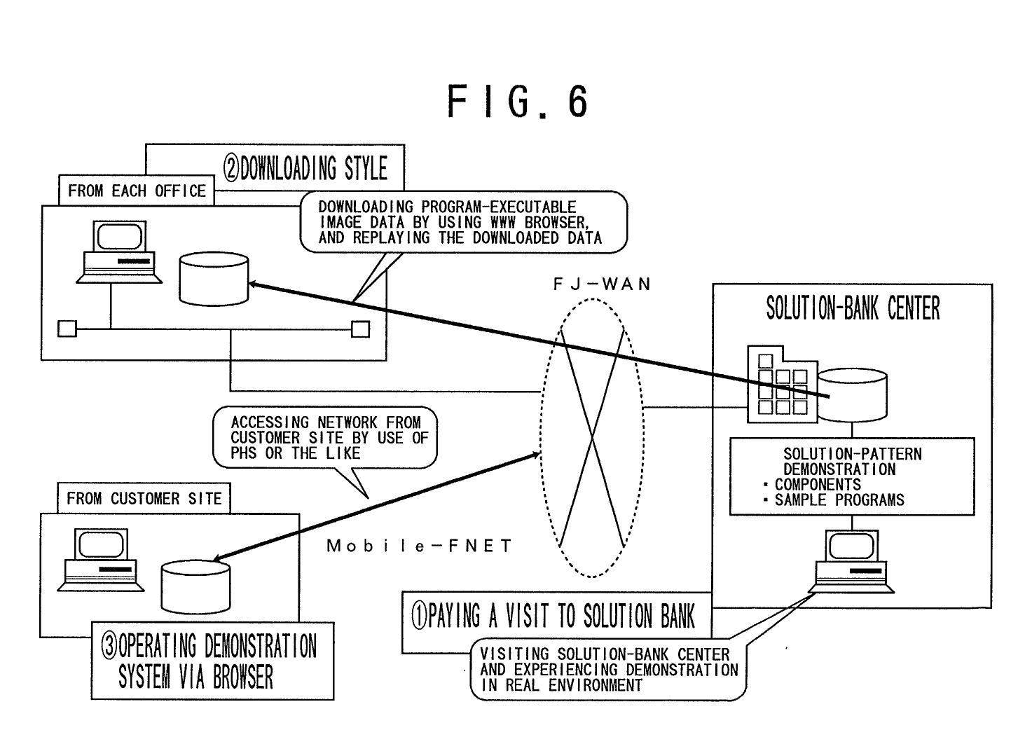

FIG. 6 is an illustrative drawing for explaining how the demonstration system of the present invention works.

As shown in the figure, the system engineer may visit the solution-bank center 200, and use a terminal therein to demonstrate the system under the real conditions by using sample programs.

Without making a visit to the solution-bank center 200, the system engineer may use a WWW browser of the system-construction-know-how extracting device 100 provided at his/her desk so as to access program-execution image data (e.g., Lotus Screen Cam) via a network (e.g., FJ-WAN). In this manner, the system engineer may download voice descriptions and replay the downloaded voice data at the system-construction-know-how extracting device 100 (personal computer).

In the case where the system engineer is posted at a site of the customer, he/she may access the solution-bank center 200 via a network (e.g., Mobile-FNET) by using a PHS (personal handy-phone) or the like in order to obtain necessary information.

In what follows, a description will be given with regard to a case in which an application environment of a default system is provided from the solution-bank center 200 so as to install the same in the system-construction-know-how extracting device 100.

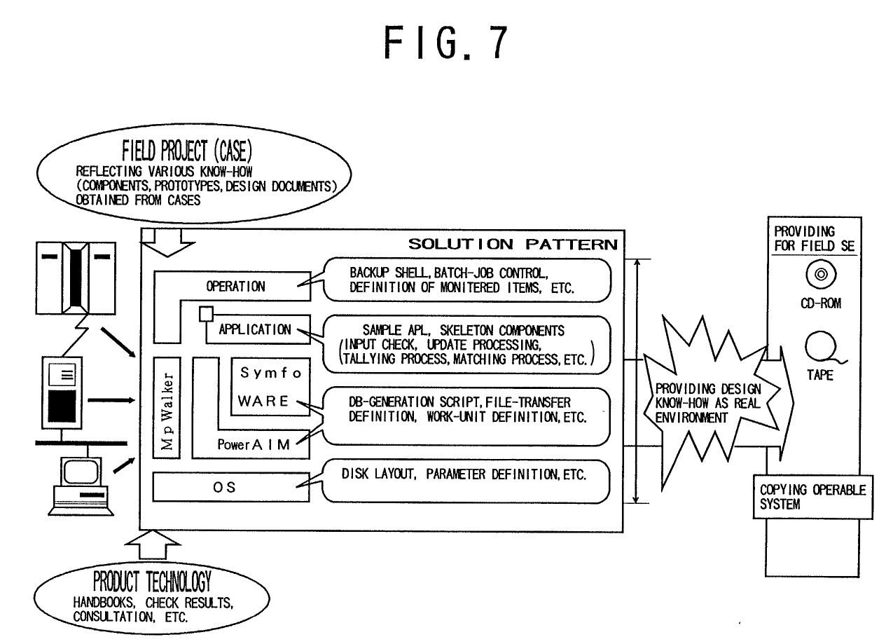

FIG. 7 is an illustrative drawing for explaining an application environment of a default system.

The solution-bank center 200 includes various exemplary cases (field projects), know-how (regarding components, formats, designs), information regarding products (e.g., handbooks, check results, consultation), or the like supplied from a set of computers connected via the network. Namely, these items are kept in the solution-bank center 200 as available solution patterns. For system-operation purposes, backup shells, batch-job control, monitor-item definitions, etc., are provided. The application system includes sample applications and skeleton components (for an input check, an updating process, a tallying process, a matching process, and the like). Further, a DB-generation unit, file-transfer definitions, work-unit definitions, and the like are provided as the Symfo WARE. The operation system includes a disk layout and parameter definitions.

The application environment (PP, definitions, components, scripts, and so on) of the default system is treated as design know-how, and is supplied to the system engineers as a real environment to work with. Because of this, the system-construction-know-how extracting device 100 can simply make a copy of systems when there is a need to install the systems operable in this environment.

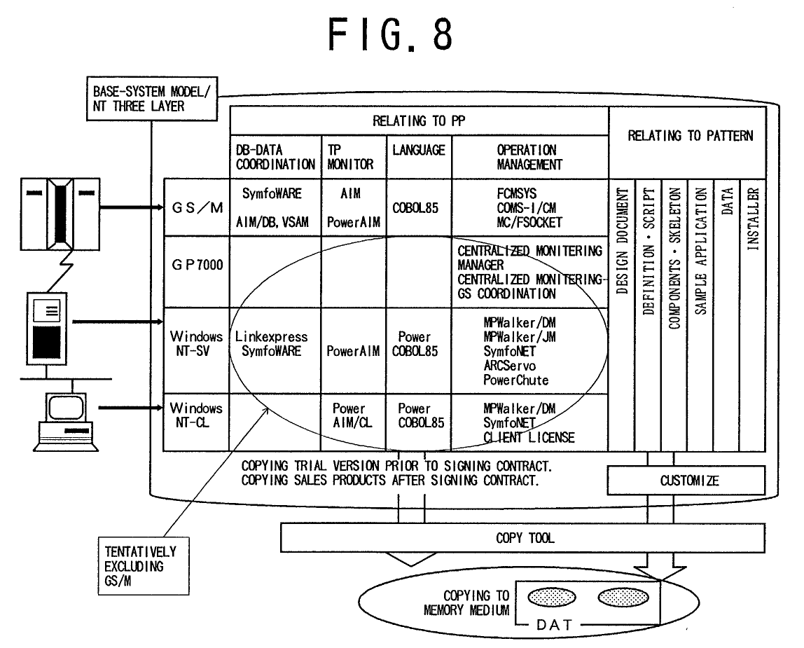

FIG. 8 is an illustrative drawing for explaining a method of providing a default system. As described above, the systems operable in the real environment include DB-data associations, TP monitors, languages, and operation management tools as PP-related information, and further include design documents, definitions/scripts, components/skeletons, sample applications, data, installers, etc., as the pattern-related information. These items are customized in accordance with each customer's needs, and are copied (installed) to the memory medium of the system-construction-know-how extracting device 100.

The PP-related information and the pattern-related information are supplied to the customer for the trial use thereof until a contract is signed. After the signing of a contract, these items are supplied as fully-arranged products.

In what follows, operations performed at the time of providing the default system will be described.

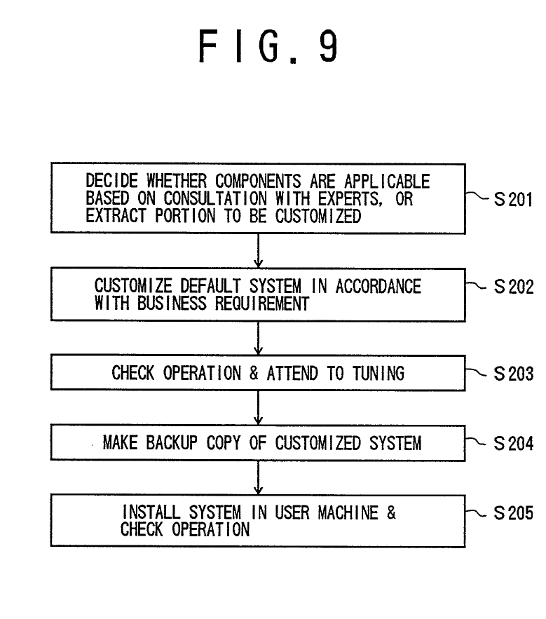

FIG. 9 is a flowchart of operations performed at the time of providing a default system according to the present invention.

At a step S201, a decision is made as to whether components of the default system are applicable after consulting with experts of the solution-bank center 200. Alternatively, portions of the default system are identified as portions needing to be customized in order to satisfy the customer needs.

At a step S202, the identified portions are customized in accordance with business requirements.

At a step S203, a check is made on operations of the customized system, and tuning is applied to enhance performance.

At a step S204, a backup system is created with respect to the customized default system.

at a step S205, the default system is installed in the user machine. After the installment, operations of the default system are checked.

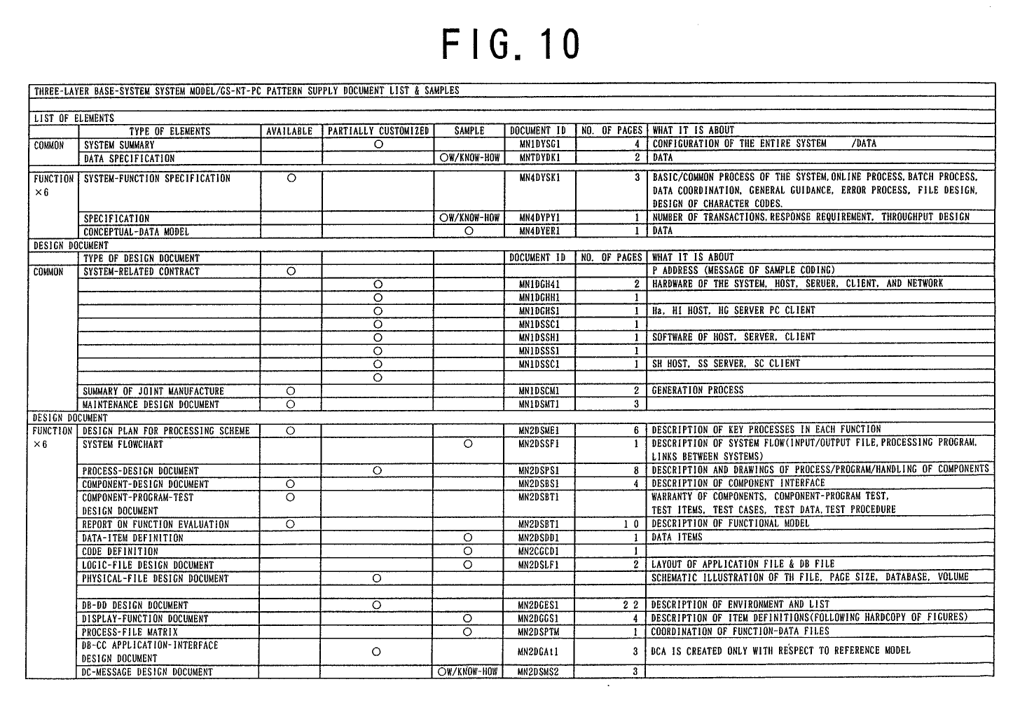

Selection of the portions needing to be customized at the step S201 is made based on the default-system-design documents as shown in FIG. 10.

In the following, a description will be given with regard to operations performed when only a partial function of the contents is downloaded from the solution-bank center 200 to the system-construction-know-how extracting device 100. This process may be useful if used in checking operations when only a partial function is installed at the step S205 described above.

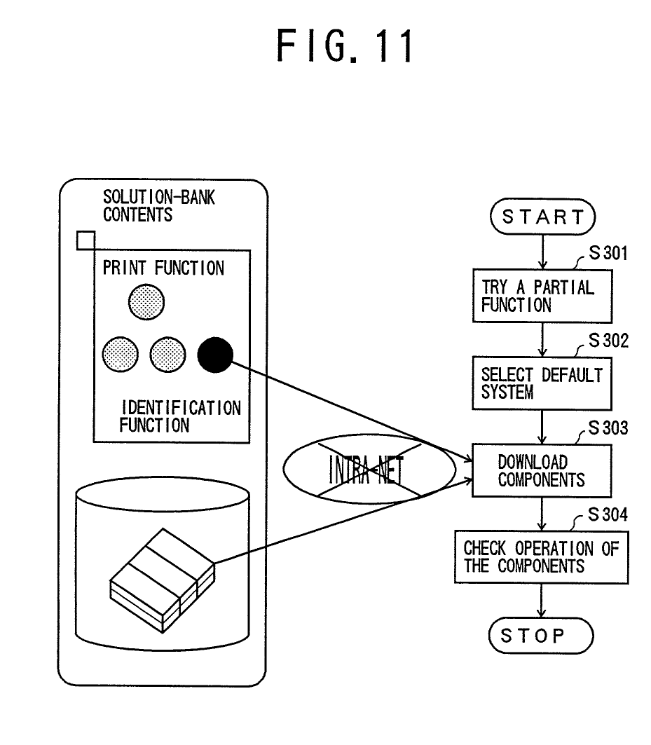

FIG. 11 is a flowchart combined with an illustrative drawing for explaining the downloading of a partial function.

At a step S301, a system engineer tries a partial function at the system-construction-know-how extracting device 100 after the partial function is installed from the solution-bank center 200.

At a step S302, a portion of the default system is selected by using a browser.

At a step S303, the selected default system is downloaded from the solution-bank center 200. In an example of FIG. 11, two functions, i.e., a print function and an identification function, are downloaded.

At a step S304, the system engineer checks the operations of the downloaded components at the system-construction-know-how extracting device 100.

In what follows, a description will be provided with regard to a process which categorizes solution patterns according to the customer's business transaction model on the side of the solution-bank center 200.

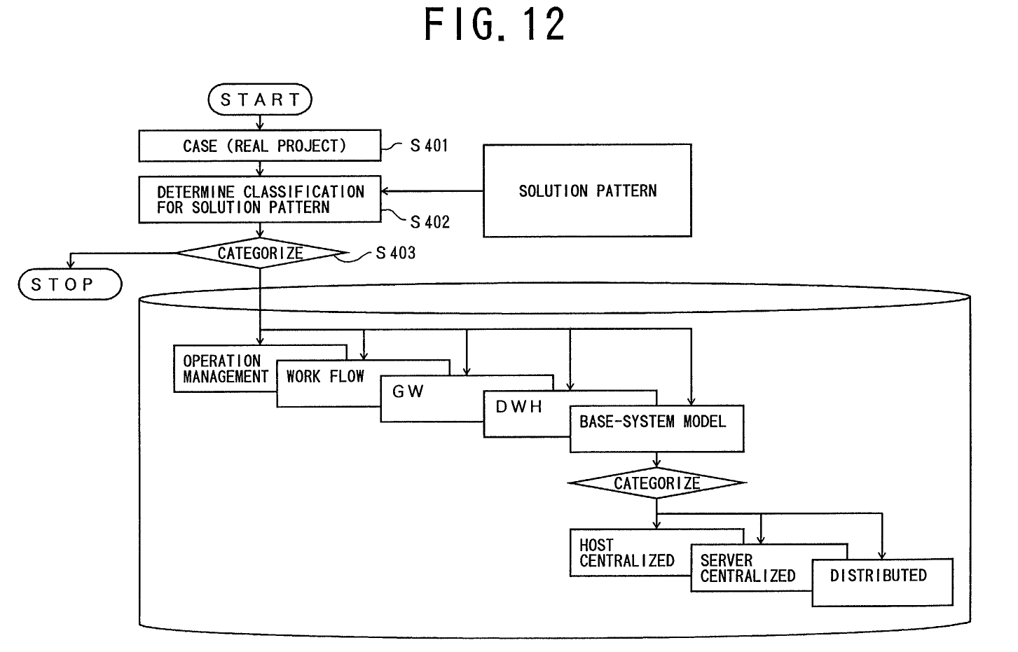

FIG. 12 is a flowchart for explaining the process of categorization according to the present invention.

At a step S401, an exemplary case is identified among real projects being engaged on the customer side.

At a step S402, the identified case is transformed into a solution pattern. Then, a classification under which the solution pattern is categorized is determined.

At a step S403, the solution pattern is categorized by the classification. Classification may include operational management, a work flow, GW, DWH, a base-system model, and so on, wherein the base-system model includes a host-centralized processing model, a server-centralized processing model, and a distributed processing model.

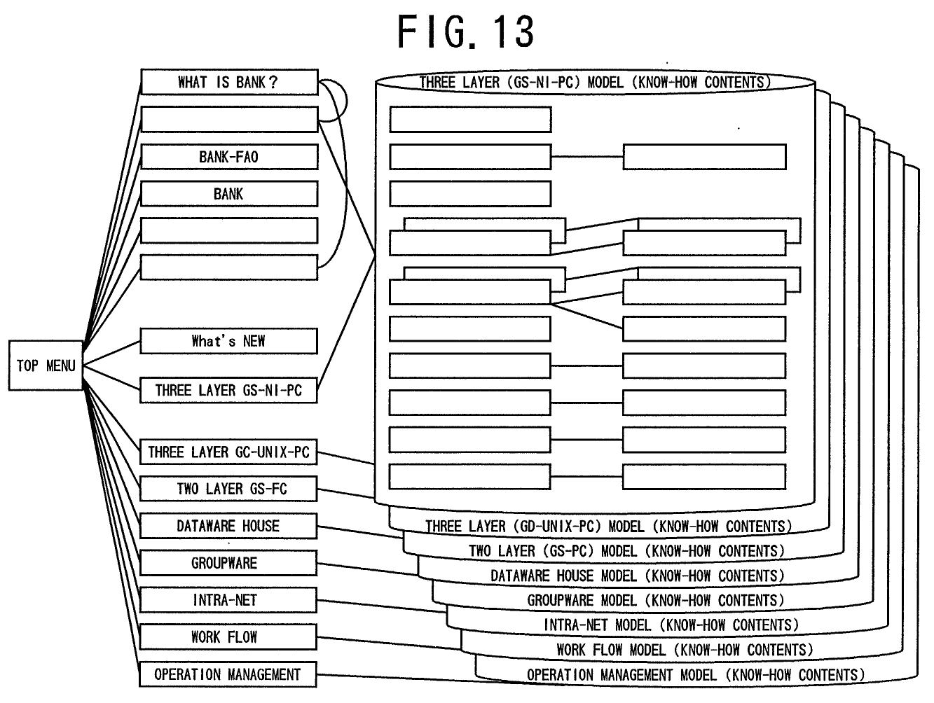

The solution pattern described above includes items which are organized in hierarchy as shown in FIG. 13, and are stored as the contents of the solution-bank center 200. There are three levels in the hierarchy in an example of FIG. 13. However, the number of levels is not limited to three, and can be any number. In the figure, the know-how contents shown as the “three level hierarchy (GS-NI-PS)” model may further include “operation-environment-expansion scenario”, “operation-environment illustrative description”, etc., and “operation-environment illustrative description” may further include “operation-environment/illustrative-description download”. The contents hierarchically organized in this manner form a base from which a necessary content is extracted and categorized.

In what follows, a description will be provided with regard to a case in which the system engineer gets hold of the contents from the system-construction-know-how extracting device 100 and evaluates the same before delivering software to the customer.

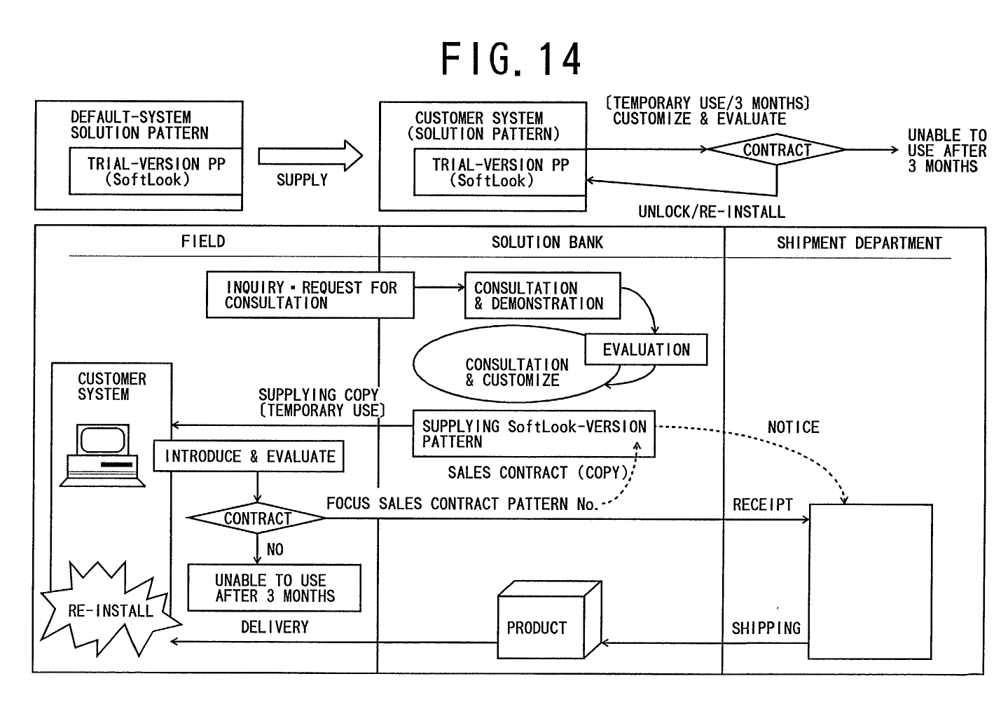

FIG. 14 is an illustrative drawing for explaining a process of evaluating software before the delivery thereof to the customer according to the present invention.

A system engineer posted at a customer site sends inquiries regarding construction of a customer system and a request for consultation from the system-construction-know-how extracting device 100 to the solution-bank center 200. In response, demonstrations are carried out as part of consultations on the side of the solution-bank center 200, and a review is made as to whether a system can be introduced. Further, the contents are supplied to the system engineer as a trial pattern (a SoftLook version) for temporary use. For example, a trial period of the SoftLook version may be set to three months with a key, so that the key is locked to prevent further use after an expiration of this time period. If the contract is extended, the key is unlocked to permit further use or allow a reinstallment of the contents.

The system engineer at the customer site installs the components supplied for temporary use in the customer computer, and evaluates the components by running these on the computer. The customers are asked to participate in the reviewing process, and decisions are made to select necessary components from the components provided as the SoftLook version. A purchase contract is made only with respect to the necessary contents. After the signing of the contract, products are delivered from the shipment division. Here, the delivered products include software and hardware or either one of them.

When the products are supplied to the customer, they are installed again.

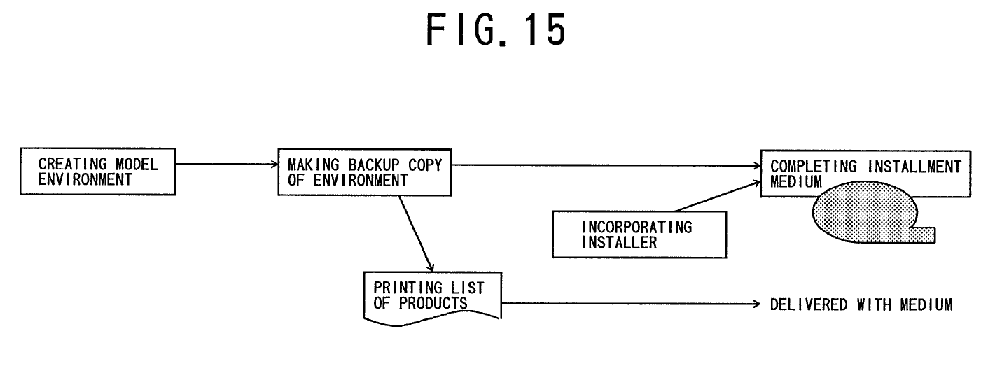

FIG. 15 is an illustrative drawing showing a process of generating an installment medium.

A system engineer on the provider side (bank) generates a model environment, and makes a backup copy of the changed portions of the systems except for the OS portions. The system engineer then prints out a list of products. After the completion of the backup-copy process, an installer is incorporated into the medium to complete the installment medium. The installment medium is then handed to a system engineer on the customer side along with the printout of the list of products.

In what follows, the procedure which the system engineer on the customer side follows after receiving the installment medium will be described.

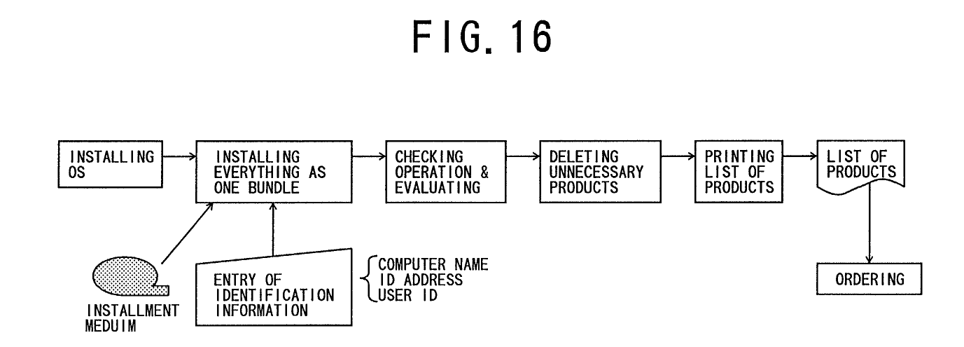

FIG. 16 is an illustrative drawing showing a process of installing all components.

An OS is first installed, and, then, the installment medium having software components recorded therein as described above is used for installing all the components. At the time of installment, identification information of the personal computer (e.g., a name of the computer, an IP address, a user ID, and so on ) is entered. A check is made on the operations of the installed software components, and an evaluation is made with respect to each of them. If there is a product that turned out to be unnecessary based on the evaluation, this product is deleted. Products which are actually purchased are named in a printout of a list of products, and the printout of the list is used for ordering.

In this manner, all the products are installed at once by using the installment medium, so that a setup time is relatively short. The system engineer on the customer side does not need special knowledge because the environment-related settings of each product are made in advance in the installment medium. Also, the identification information of the computer is entered on the same screen, so that there is little room for typographical mistakes. Since the environment is checked in advance as to the operability thereof, evaluation of the operations thereof can be readily made immediately after the installment of the products. Further, since the actual order to purchase the products is made after making the evaluation, an accurate order without omission or excess items can be made. The list of the products includes necessary products and order codes (product codes) thereof, so that a time to fill out the order can be shortened.

In summary, tasks of the system engineers between the customer side and the bank side are as follows.

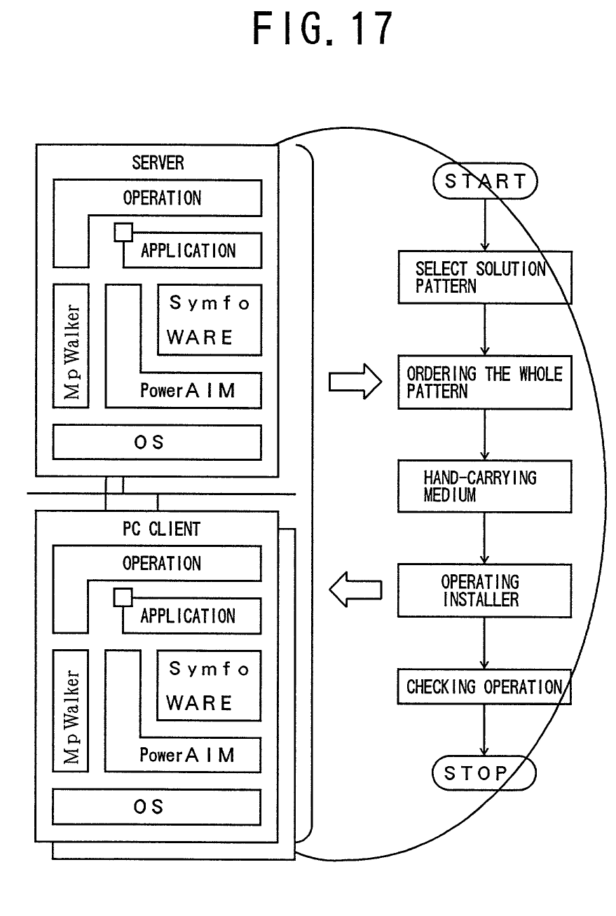

FIG. 17 is an illustrative drawing showing a procedure that system engineers follow according to the present invention.

As shown in FIG. 17, the system engineers select a solution pattern from the solution patterns stored in the solution-bank center 200 by operating on the system-construction-know-how extracting device 100 so that the selected solution pattern is applicable to the customer with whom business talks are underway, and download software components from the solution-bank center 200 to a memory medium with respect to the selected solution pattern. The contents stored in the medium is then installed in the customer-side computer by operating the installer. Finally, the installed contents are operated, and are subjected to operation checks.

A description will be given below with regard to a case in which checked components, sample applications, or the like provided in the default system are subjected to reuse thereof. Here, the reuse of the checked components may be made with respect to packaged components or any other forms of components. Such information about a default system as PP, components, environment definitions, sample applications, and so forth is copied to a check system of the SI vendor, where a technical evaluation is made on the default system. Then, such tools as performance tools, design know-how, trouble information, standardization information, etc., are transferred from the default system to a target system. In the target system, copied and checked components are subjected to reuse thereof for design purposes, and are used in another system. In this manner, high productivity and high quality can be achieved.

In the following, an embodiment of the present invention will be described.

In an example set forth in the following, a description will be given with regard to a case in which a system is constructed for a customer by a field system engineer (working at the customer site) interacting with the solution-bank center 200.

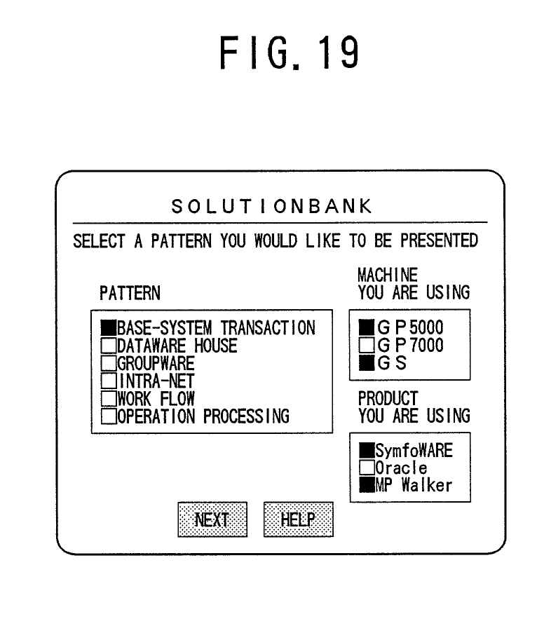

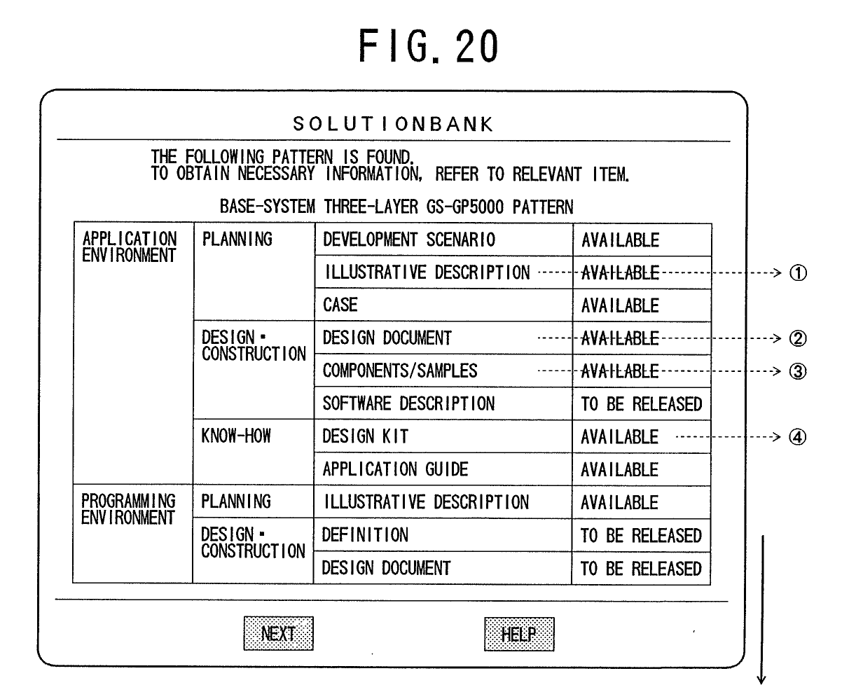

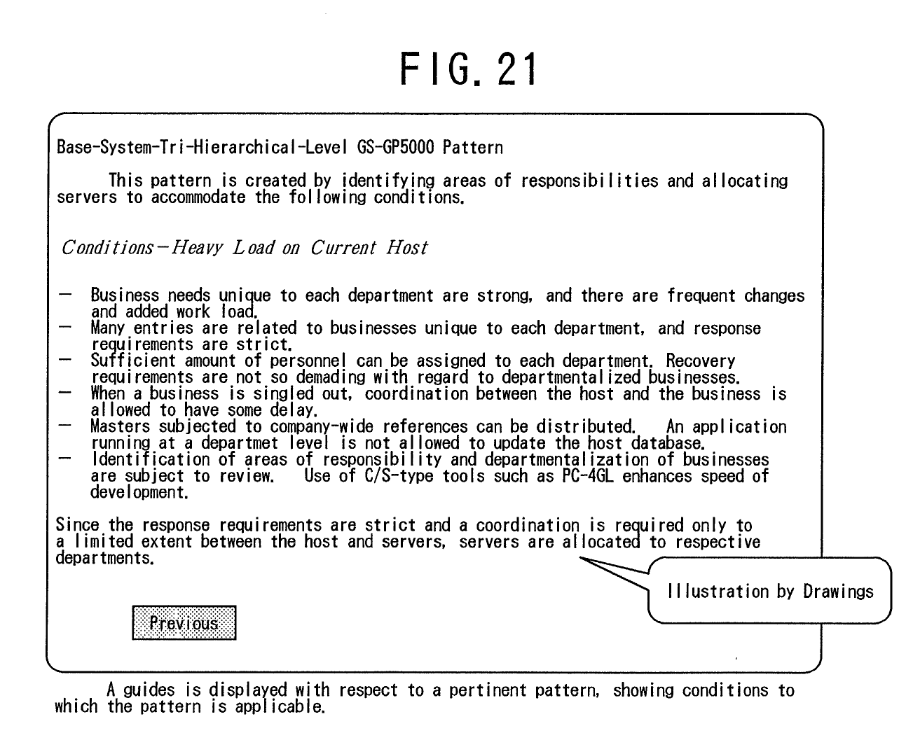

FIG. 19 is an illustrative drawing showing an example of a displayed screen used at the time of solution-pattern selection according to an embodiment of the present invention. FIG. 20 is an illustrative drawing showing an example of another displayed screen used at the time of solution-pattern selection, and FIG. 21 is an illustrative drawing showing an example of yet another displayed screen used at the time of solution-pattern selection.

On a browser screen shown in FIG. 19, items for multiple choices are shown with respect to a pattern, a machine being used, and a product being used. In this example, the system engineer selects “base-system transaction” for the pattern, “GP5000” and “GS” as the machine he/she is using, and “SymfoWARE” as the product he/she is using. Based on these selections, a search result is obtained from the solution-bank center 200 as shown in FIG. 20, providing information about “base-system-tri-hierarchical-level GS-GP5000” displayed on the browser screen. It is possible that a plurality of search results are obtained, in which case these results may be displayed by use of a scroll bar.

In the example of FIG. 20, the system engineer selects an illustrative-description document from the item “planning”, a design document and components/samples from the item “design/construction”, and a design kit from the item “know-how” under the title “application environment”.

As a consequence of the selection, a guide as shown in FIG. 21 is displayed so as to indicate conditions to which the base-system-tri-hierarchical-level GS-GP5000 pattern can be properly applied. Using this guide, the system engineer proceeds with a task of selecting components meeting the customer needs.

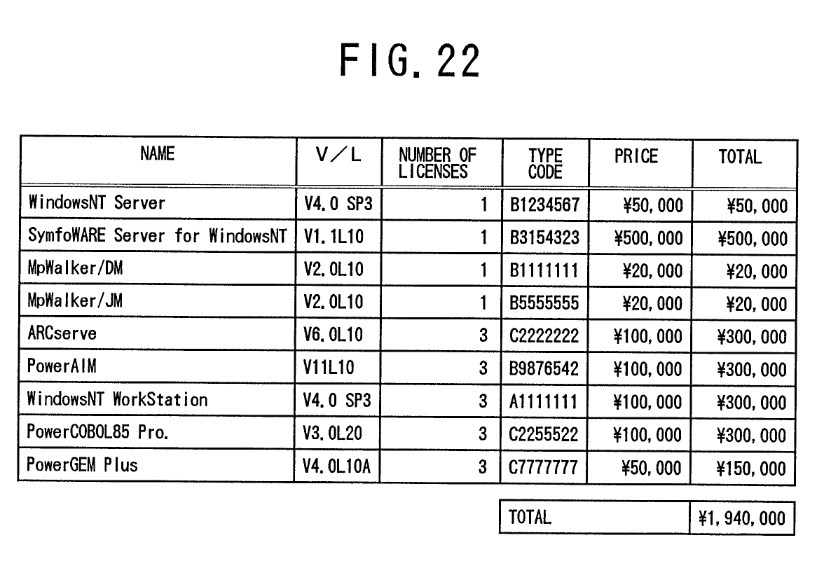

In this manner, the bank side receives information about components selected by the system engineer posted at the customer site. Upon receipt of the information, a list as shown in FIG. 22 is generated. In this example, FIG. 22 shows a list of software products used by the customer, and the list is comprised of such column fields as software names, functions, prices, etc. When the system engineer at the customer site receives the list, the list can be shown to the customer as a quota. The system engineer at the customer site deletes unnecessary items from the list, and adds necessary items to the list. In this manner, the customer can avoid signing a contract including unnecessary items by simply deleting them from the list.

The present invention is readily implemented as software embodying functions of the system-construction-know-how extracting device 100 and the solution-bank center 200. Such software may be stored in a computer-readable memory medium connected to the hardware of the system-construction-know-how extracting device 100 and the solution-bank center 200, and the memory medium may be provided in the form of a floppy disk, a hard drive, CD-ROM, or the like. The solution system is implemented by installing the software in the respective devices.

Further, the present invention is not limited to these embodiments, but various variations and modifications may be made without departing from the scope of the present invention.

What is claimed is:

1. A method of constructing a system by collecting information and know-how, comprising the steps of:
storing information including development situations, know-how, and knowledge in a solution bank by a unit of a solution pattern; and
obtaining contents corresponding to a desired system so as to construct the desired system by accessing the solution bank from a computer in which the desired system is to be constructed.

2. The method as claimed in claim 1, wherein the solution bank stores information on an application environment including proposals, designs, software, know-how, and a programming environment.

3. The method as claimed in claim 1, wherein said step of obtaining contents comprises the steps of:
accessing the solution bank based on information including a business model, transaction forms, and a project size; and
selecting items of desired information from items presented by the solution bank.

4. The method as claimed in claim 1, wherein said step of obtaining contents comprises the steps of:
accessing the solution bank based on information including a solution pattern, a machine being used, a product being used; and
supplying an application environment of a default system from the solution bank to the computer in which the desired system is to be constructed.

5. The method as claimed in claim 4, wherein said step of obtaining contents further comprises the step of supplying design documents of the default system from the solution bank to the computer in which the desired system is to be constructed.

6. The method as claimed in claim 1, wherein the solution bank provides a solution pattern categorized according to a business-transaction model which is requested by the computer in which the desired system is to be constructed.

7. The method as claimed in claim 1, wherein the solution bank provides only a partial function of a solution pattern for the computer in which the desired system is to be constructed.

8. The method as claimed in claim 1, further comprising the steps of:
checking components incorporated into a default system which is used as a basis for the desired system; and
utilizing the checked components for a computer in which another system is to be constructed.

9. A system for constructing a system by collecting information and know-how, comprising:
a solution bank including:
content storing means for storing information including development situations, know-how, and knowledge by a unit of a solution pattern; and
solution-pattern providing means for providing the information stored in said content storing means as a solution pattern or a portion of the solution pattern in response to a request; and
a system-construction device which obtains contents corresponding to a desired system from said solution bank so as to construct the desired system by accessing said solution bank.

10. The system as claimed in claim 9, wherein said solution bank stores information on an application environment including proposals, designs, software, know-how, and a programming environment.

11. The system as claimed in claim 9, wherein said system-construction device comprises:
accessing means for accessing said solution bank based on information including a business model, transaction forms, and a project size; and
selecting means for selecting items of desired information from items presented by said solution bank.

12. The system as claimed in claim 11, wherein said access means accesses said solution bank based on information including a solution pattern, a machine being used, a product being used, and said solution-pattern providing means supplies an application environment of a default system from said solution bank to said system-construction device.

13. The system as claimed in claim 12, wherein said solution-pattern providing means further supplies design documents of the default system from said solution bank to said system-construction device.

14. The system as claimed in claim 9, wherein said solution-pattern providing means provides a solution pattern categorized according to a business-transaction model which is requested by said system-construction device.

15. The system as claimed in claim 9, wherein said solution-pattern providing means provides only a partial function of a solution pattern for the system-construction device.

16. A machine-readable memory medium having a program embodied therein for constructing a system by collecting information and know-how, said program comprising:
a solution-pattern providing program-code device configured to cause a solution bank, which stores information including development situations, know-how, and knowledge by a unit of a solution pattern, to provide the information as a solution pattern or a portion of the solution pattern in response to a request; and
a system-construction program-code device configured to cause a system-construction device to obtain contents corresponding to a desired system from the solution bank so as to construct the desired system by accessing the solution bank.
